(19) United States
(12) Patent Application Publication
(10) Pub. No.: US 2006/0073390 A1
(43) Pub. Date: Apr. 6, 2006

(54) Solid electrolyte

(75) Inventors: Atsushi Omote, Osaka-fu (JP); Tomoko Suzuki, Nara-ken (JP); Masa-aki Suzuki, Osaka-fu (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/241,929

(22) Filed: Oct. 4, 2005

(30) Foreign Application Priority Data
Oct. 6, 2004 (JP) 2004-293512

(51) Int. Cl. H01M 10/36; C04B 35/495; C01G 25/00; C01G 27/00

(52) U.S. Cl. 429/304; 501/104

(57) ABSTRACT

The present invention provides a material capable of demonstrating a higher ion conductivity. The present invention relates to a solid electrolyte substantially comprising a crystal body represented by a chemical formula (RM) (QO₄)₃ (here, R is at least one species of Zr and Hf, M is at least one species of Mg, Ca, Sr, Ba, and Ra, and Q is at least one species of W and Mo).

### FIELD OF THE INVENTION

The present invention relates to a solid electrolyte suitable for electrochemical devices such as batteries, gas sensors, and ion concentration sensors.

### BACKGROUND OF THE INVENTION

Solid electrolytes of ion conductive polymers or oxygen ion conductors (ZrO₂, CeO₂, and the like) have been used for a long time in electrochemical devices such as batteries, gas sensors, and ion concentration sensors. In recent years a large number of proton conductors or oxygen ion conductors for fuel cells have been studied and perovskite-type oxides (LaGaO₃, LaSrGaCoO₃, and the like) having a high oxygen ion conductivity have been disclosed and attracted attention (Japanese Published Patent Application Nos. 2000-113898 and H11-335164).

As solid electrolytes comprising ions other than oxygen ions, it is known that solid electrolytes with monovalent metal ions as movable species generally demonstrate a high ion conductivity. A sodium ion conductor such as β-alumina or a lithium ion conductor such as sulfide glass is disclosed (Japanese Examined Patent Publication No. H7-106938 and Japanese Patent No. 3433173).

Tungstic acid complex oxides and phosphoric acid complex oxides of various kinds are disclosed as solid electrolytes of trivalent or tetravalent metal ions (Japanese Published Patent Application Nos. H7-249416 and H11-203935, Chem. Mater., Vol. 12, No, 7, 2000, and Solid State Communications, 123 (2002), 411-415). Among them, specific characteristics of solid electrolytes represented by formulas A₂(WO₄)₃ and A₂(MoO₄)₃ (A is a trivalent metal element) as trivalent metal ion conductors are reported.

Because those solid electrolytes are polyvalent ion conductors and enable a high-density charge transfer, they are expected to find application in electrochemical devices, and the application of some of them to gas sensors and solid electrolyte secondary batteries are also disclosed (Japanese Published Patent Application Nos. 2001-174433 and H10-255822).

Furthermore, tungstic acid compounds represented by the chemical formula (R⁴⁺M²⁺) (Qo₄)₃ (where R is Zr, Hf, or a tetravalent metal element represented by the mixed system thereof, M is Mg, Ca, Sr, Ba, Ra, or a divalent metal element represented by a mixed system thereof, and Q is a hexavalent metal element selected from W and Mo or a metal element represented by a mixed system thereof) are disclosed as materials with a negative thermal expansion coefficient (Japanese Published Patent Application No. 2003-324423).

Japanese Published Patent Application No. 2000-082327 discloses that a solid electrolyte composite sample obtained by dispersing zirconium phosphooxide in a polycrystalline body of magnesium zirconium phosphate demonstrates a high divalent magnesium ion conductivity.

Japanese Published Patent Application No. 2001-076533 discloses a solid electrolyte composed of Mg₁₋₂ₓ (Zr₁₋ₓNbₓ)₄P₆O₂₄ and having Mg²⁺, which is a divalent cation, as a conductive species.

Japanese Published Patent Application Nos. S59-182271, S55-071670, and S55-071669 disclose solid electrolyte composed of ceramics.

### SUMMARY OF THE INVENTION

In tungstic acid complex oxides represented by A₂(WO₄)₃, A₂(MoO₄)₃ (A is a trivalent metal element), high-density charge transfer is possible because of the transfer of trivalent metal ions (A³⁺)

However, ion conductivity is a phenomenon of ions moving through lattice points of a crystal or interstitially in a solid electrolyte, and the problem is that trivalent metal ions are strongly bonded to the ions forming the crystal lattice and a high ion conductivity cannot be obtained.

Furthermore, none of the references discloses a solid electrolyte composed of a tungstic acid salt with a conductivity provided by divalent cations represented by Mg²⁺.

Accordingly, it is a main object of the present invention to provide a material capable of demonstrating a higher ion conductivity.

As a result of the study conducted in consideration of the above-described problems inherent to the conventional technology, the inventors have discovered that a material having a specific composition can attain the above-described object. This discovery led to the creation of the present invention.

Thus, the present invention relates to the below-described solid electrolyte.

1. A solid electrolyte substantially consisting of a crystal body represented by a chemical formula (RM)(QO₄)₃, wherein R is at least one selected from the group consisting of Zr and Hf, M is at least one species of Mg, Ca, Sr, Ba, and Ra, and Q is at least one selected from the group consisting of W and Mo.

2. The solid electrolyte according to above 1, wherein M comprises at least Mg.

3. The solid electrolyte according to above 1, wherein M is a mixed system of Mg and at least one selected from the group consisting of Ca, Sr, Ba, and Ra.

4. The solid electrolyte according to above 1, wherein the crystal system of the crystal body is an orthorhombic system.

5. The solid electrolyte according to above 1, wherein the electric conductivity at 600° C. of the solid electrolyte is 8×10⁻⁵ Ω⁻¹·cm⁻¹ or more.

6. A laminated body comprising (1) an anode, (2) a cathode, and (3) a solid electrolyte sandwiched between the anode and the cathode, wherein the solid electrolyte is the solid electrolyte according to above 1.

7. The laminated body according to above 6, wherein the anode is (a) a divalent metal of at least one selected from the group consisting of Mg, Ca, Sr, Ba, and Ra or (b) an alloy comprising at least one selected from the group consisting of such divalent metals.

8. The laminated body according to above 6, wherein the cathode is an alloy comprising at least one selected from the group consisting of divalent metals of at least one selected from the group consisting of Mg, Ca, Sr, Ba, and Ra.

9. The laminated body according to above 6, wherein M comprises at least Mg.

10. The laminated body according to above 6, wherein M is a mixed system of Mg and at least one selected from the group consisting of Ca, Sr, Ba, and Ra.

11. The laminated body according to above 6, wherein the crystal system of the crystal body is an orthorhombic system.

12. The laminated body according to above 6, wherein the electric conductivity at 600° C. of the solid electrolyte is 8×10⁻⁵ Ω⁻¹·cm⁻¹ or more.

13. A secondary battery having a laminated body comprising (1) an anode, (2) a cathode, and (3) a solid electrolyte sandwiched between the anode and the cathode, wherein the solid electrolyte is the solid electrolyte according to above 1.

14. The secondary battery according to above 13, wherein the anode is (a) a divalent metal of at least one selected from the group consisting of Mg, Ca, Sr, Ba, and Ra or (b) an alloy comprising at least one selected from the group consisting of such divalent metals.

15. The secondary battery according to above 13, wherein the cathode is an alloy comprising at least one selected from the group consisting of divalent metals of at least one selected from the group consisting of Mg, Ca, Sr, Ba, and Ra.

16. The secondary battery according to above 13, wherein M comprises at least Mg.

17. The secondary battery according to above 13, wherein M is a mixed system of Mg and at least one selected from the group consisting of Ca, Sr, Ba, and Ra.

18. The secondary battery according to above 13, wherein the crystal system of the crystal body is an orthorhombic system.

19. The secondary battery according to above 13, wherein the electric conductivity at 600° C. of the solid electrolyte is 8×10⁻⁵ Ω⁻¹·cm⁻¹ or more.

20. The secondary battery according to above 13, wherein (A) the anode is (a) a divalent metal of at least one selected from the group consisting of Mg, Ca, Sr, Ba, and Ra or (b) an alloy comprising at least one selected from the group consisting of such divalent metals; (B) the cathode is an alloy comprising at least one selected from the group consisting of divalent metals of at least one selected from the group consisting of Mg, Ca, Sr, Ba, and Ra; and (C) the divalent metal content of the anode is different from that of the cathode.

### BRIEF DESCRIPTION OF THE DRAWINGS

FIG. 1 illustrates the measurement of electric conductivity of a solid electrolyte of one Example of the present invention;

FIG. 2 illustrates a solid electrolyte secondary battery of one Example of the present invention;

FIG. 3 shows the electric conductivity measurement results obtained in Example 1;

FIG. 4 shows the electric conductivity measurement results obtained in Example 2 and Example 3; and

FIG. 5 shows a solid-electrolyte CO₂ gas sensor.

### DESCRIPTION OF THE INVENTION

Solid Electrolyte

The solid electrolyte in accordance with the present invention substantially comprises a crystal body represented by a chemical formula (RM) (QO₄)₃ (R is at least one selected from the group consisting of Zr and Hf, M is at least one selected from the group consisting of Mg, Ca, Sr, Ba, and Ra, and Q is at least one selected from the group consisting of W and Mo).

R is a tetravalent metal and M is a divalent metal. In the solid electrolyte, the conductivity is provided by M²⁺ as M.

The aforementioned R is a tetravalent metal element (that is, R(IV)) of at least one species of Zr and Hf. Furthermore, the aforementioned M is a divalent metal element I (that is, M(II)) of at least one selected from the group consisting of Mg, Ca, Sr, Ba, and Ra. Q is a hexavalent metal element (that is, Q(VI)) of at least one selected from the group consisting of W and Mo. Those can be appropriately combined according to the application or usage method of the material in accordance with the present invention.

More specific examples include (HfMg) (WO₄)₃, (ZrMg) (WO₄)₃, (HfCa) (WO₄)₃, (ZrCa) (WO₄)₃, (HfMg) (MoO₄)₃, (ZrMg) (MoO₄)₃, (ZrₓHf₁₋ₓMg) (WO₄)₃ (0<x<1), (ZrₓHf₁₋ₓCa) (WO₄)₃ (0<x<1), (ZrMgₓCa₁₋ₓ) (WO₄)₃ (0<x<1), (HfMgₓCa₁₋ₓ) (WO₄)₃ (0<x<1) (HfMg) (W_{y}Mo_{1-y}O₄)₂ (0<y<1), and (ZrMg) (W_{y}Mo_{1-y}O₄)₃ (0<y<1). No limitation is placed on those complex oxides, provided that they can be represented by the above-described chemical formulas.

In accordance with the present invention, among the divalent metals, magnesium, which has the smallest ion radius, is preferably used because a higher ion conductivity can be obtained. Thus, it is preferred that at least Mg be comprised.

The solid electrolyte in accordance with the present invention substantially comprises a crystal body having the above-described composition. Therefore, small amounts of amorphous phase and impurities may be contained, so long as they do not adversely affect the prescribed effect of the present invention is not lost. The crystal body in accordance with the present invention is basically a polycrystalline body. Furthermore, it is especially preferred that the crystal system of the crystal body be an orthorhombic system. Employing such a crystal structure makes it possible to demonstrate an even better ion conductivity.

The mean crystal grain size of the crystal body in accordance with the present invention can be determined according to the application and utilization object of the material in accordance with the present invention, but usually may be within a range of about 2 to 10 μm.

The electric conductivity (600° C.) of the solid electrolyte in accordance with the present invention can be appropriately set by changing the composition according to the prescribed object, physical properties, and the like, but it is usually 8×10⁻⁵ Ω⁻¹·cm⁻¹ or more, preferably 1×10⁻⁴ Ω⁻¹·cm⁻¹ or more, even more preferably 5×10⁻⁴ Ω⁻¹·cm⁻¹ or more.

Method for Manufacturing the Solid Electrolyte

The solid electrolyte in accordance with the present invention may be manufactured by a liquid-phase method, a gas-phase method, or a solid-phase method, provided that the crystal body having the above-described composition is obtained. A solid-phase reaction method can be used as a solid-phase method, a precipitation method, a sol-gel method, and a hydrothermal reaction method can be used as a liquid-phase method, and sputtering or CVD can be used as a gas-phase method.

More specifically, the solid electrolyte in accordance with the present invention can be advantageously manufactured, for example, by the following solid-phase method. A general mixed oxide can be fabricated in the sequence of operations including mixing and grinding or kneading metal oxides serving as starting materials by using an apparatus such as a ball mill, and then calcining, coarsely grinding, molding, and firing. The material in accordance with the present invention basically can be also produced by such a general manufacturing method. In this case, the desired material can be prepared without calcining, if a sufficiently fine powder is obtained in the mixing and grinding process.

Each element R, M, and Q can be directly used as a starting material, but respective compounds (compounds comprising at least one selected from the group consisting of R, M, and Q) that can become the supply sources thereof can be also used. Examples of such compounds include oxides, hydroxides, carbonates, nitrates, chlorides, acetates, oxalates, metal alkoxides, metal acetylacetonates, metal acetates, metal methacrylates, and metal acrylates. Compounds comprising two or more such elements can be also used.

Examples of R compounds that can be used include zirconium oxide and hafnium oxide.

Examples of M compounds that can be used include magnesium oxide, calcium oxide, strontium oxide, magnesium hydroxide, calcium hydroxide, magnesium carbonate, and calcium carbonate.

Examples of Q compounds that can be used include tungsten oxide and molybdenum oxide.

Examples of compounds that comprise two or more such elements include MgWO₄, CaWO₄, SrWO₄, HfW₂O₈, and ZrWA₂O₈.

In accordance with the present invention, in addition to those starting materials, if necessary, the usual additives (binders, sintering agents, and the like) that are used in the manufacture of sintered bodies can be also added.

Furthermore, a variety of additives can be used with the object of increasing compactness and improving reproducibility of material properties. Thus, oxides or compounds of Mg, Ca, Ba, Al, Y, Sc, Lu, Zr, Hf, W, Mo, Fe, Mn, Ni, and Si can be used as the additives. More specifically, oxides such as magnesium oxide, calcium oxide, aluminum oxide, yttrium oxide, scandium oxide, iron oxide, manganese dioxide, silicon dioxide, nickel oxide, zirconium oxide, hafnium oxide, and tungsten oxide; hydroxides such as magnesium hydroxide, calcium hydroxide, and aluminum hydroxide; and carbonates such as magnesium carbonate, calcium carbonate, and barium carbonate, can be used. Those additives may be used in combinations of a plurality thereof. Those additives are preferably used in an amount of 5 wt. % or less, more preferably 0.1 to 2 wt. % per 100 wt. % of the oxide serving as the main starting material. If the amount added is too small, no sufficient effect can be produced, and if the amount added is 5% or more, the material might melt due to decrease in a melting point or the additive might react with part of the main starting material or the entire main starting material, thereby adversely affecting the ion conduction characteristic.

Those starting materials are weighed to obtain the composition of the material in accordance with the present invention and then mixed. No specific restriction is placed on the mixing method and any known method can be employed. For example, mixing can be advantageously implemented by using an apparatus capable of mixing and grinding, for example, a grinding machine, a ball mill, a planetary mill, a medium mill (for example, an attritor and a vibration mill). Mixing and grinding may be conducted by a wet or dry process. The mean particle size of the mixed powder generally may be controlled within a range of about 0.1 to 2 μm.

If necessary, the mixed powder thus obtained can be calcined. The calcining generally may conduced in an oxidizing atmosphere or air at a temperature of about 650 to 1000° C. The calcining time can be appropriately determined according to the calcining temperature or the like.

Then, the above-described mixed powder is molded. No specific limitation is placed on the molding method, and for example, pressure molding, cast molding, a doctor blade method, and extrusion molding may be used. Furthermore, a method using a green sheet employing various sheet coating machines can be also used. In accordance with the present invention, the same profitable effect can be obtained with all the molding methods. No specific limitation is placed on the density of the molded body and it may be set appropriately according to the desired properties or the like.

The molded body is then fired. The firing temperature can be set appropriately within a range of 650 to 1300° C. according to the composition of the solid electrolyte in accordance with the present invention. For example, a temperature of 900° C. to 1100° C. is preferred for tungsten complex oxides, and a temperature of 700° C. to 900° C. is preferred for molybdenum oxides. If the firing temperature is too low, the reaction of oxide might be insufficient and the desired compound might not be obtained. Furthermore, when the firing temperature is too high, the compound tends to melt or tungsten oxide or molybdenum oxide tends to sublimate. The firing atmosphere generally may be an oxidizing atmosphere or air. The firing time can be set appropriately correspondingly to the firing temperature or the like.

Laminated Body

The present invention includes a laminated body comprising (1) an anode, (2) a cathode, and (3) a solid electrolyte sandwiched between the anode and cathode, wherein the solid electrolyte is the solid electrolyte in accordance with the present invention.

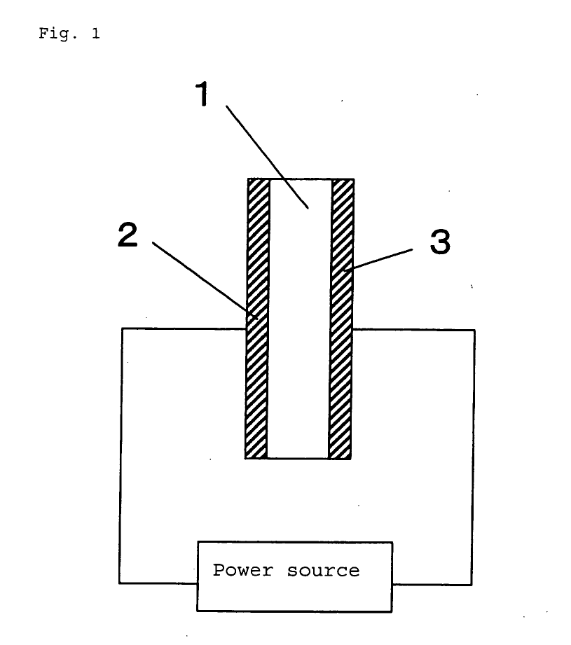

An embodiment of the laminated body is shown in FIG. 1. As shown in the figure, it has a configuration in which the solid electrolyte in accordance with the present invention is sandwiched between an electrode (anode 2) and an electrode (cathode 3), and ion conductivity is exhibited when a voltage is applied between the electrodes. No specific limitation is placed on the electrodes, provided that they are from conductive materials. In particular, metal electrodes can be advantageously used because they have a high conductivity. For example, electrode materials comprising the usually used metals such as Au, Pt, Al, Ag, Cu, Mg, Ni, Ti, and Fe or alloys comprising at least one of such metals can be employed as the metal electrodes.

When (R⁴⁺M²⁺) (QO₄)₃ in accordance with the present invention is used as the solid electrolyte, it is preferred that the material of the anode 2 be selected based on the type of metal ions moving through the crystal lattice. In the vicinity of the anode 2, M²⁺ ions present in the electrolyte move toward the cathode 3. Therefore, the number of M²⁺ in the solid electrolyte decreases and the crystal structure and ion conductivity of the solid electrolyte change gradually. If M (metal) an alloy containing M is used as the anode 2, M emits electrons in the vicinity of the anode 2, M²⁺ is generated, and the M²⁺ can be taken into the solid electrolyte. Therefore, the change of the solid electrolyte can be effectively prevented. It is desirable that a metal of at least one selected from the group consisting of Mg, Ca, Sr, Ba, and Ra or an alloy comprising a metal of at least one selected from the group consisting of those metals can be used as the material for the anode 2. An alloy of at least one selected from the group consisting of Au—Mg alloys, Ca—Mg alloys, Mg—Ni alloys, Ca—Ni alloys, Mg—Zn alloys and Al—Mg alloys can be used as the aforementioned alloy. Among the above-mentioned metals or alloys, the metals other than Mg easily react with water present in the air, forming hydroxides or oxides. Therefore, it is especially preferred that Mg or an alloy comprising Mg be used as the electrode.

In the vicinity of the cathode 3, M²⁺ accepts electrons to precipitate M or to form an alloy with the metal used for the cathode 3. The cathode 3 produces no effect on the solid electrolyte and no restriction is placed thereon in the present embodiment. For example, an alloy comprising at least one selected from the group consisting of divalent metals of at least one selected from the group consisting of Mg, Ca, Sr, Ba, and Ra can be advantageously used for the cathode.

No specific limitation is placed on a method for forming electrodes (anode and cathode), provided that they assume a configuration sandwiching the solid electrolyte. In particular, if (1) a method for forming a coating film using a paste of Pt, Au, Ag, or the like and (2) a vapor-phase method such as sputtering or vapor deposition is used, a sufficient electric contact can be ensured between the solid electrode and electrodes. Therefore, it is preferred that those methods be employed.

Secondary Battery

The present invention also includes a secondary battery having a laminated body comprising (1) an anode, (2) a cathode, and (3) a solid electrolyte sandwiched between the anode and the cathode, wherein the solid electrolyte is the solid electrolyte in accordance with the present invention.

The above-described laminated body can be used as the laminated body. In the secondary battery in accordance with the present invention, a plurality of the laminated bodies can be disposed as unit cells. Furthermore, other structural elements can be identical to those of the known secondary batteries.

A concentration cell can be readily assembled, for example, by selecting materials (electrodes) such that provide a difference in concentration of divalent metal ions for the anode and cathode. Thus, a secondary battery can be advantageously used in which (A) the anode is (a) a divalent metal of at least one selected from the group consisting of Mg, Ca, Sr, Ba, and Ra or (b) an alloy comprising at least one selected from the group consisting of such divalent metals; (B) the cathode is an alloy comprising at least one selected from the group consisting of divalent metals of at least one species of Mg, Ca, Sr, Ba, and Ra; and (C) a difference is provided between the contents of the divalent metals in the anode and the cathode. The aforementioned difference in concentration may be set appropriately according to the desired electromotive force or the like.

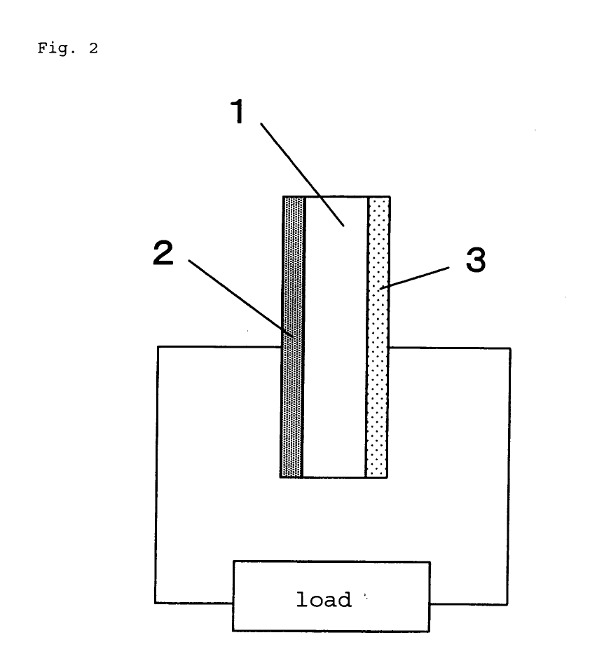

A concentration cell will be explained below with reference to FIG. 2. Referring to FIG. 2, the solid electrolyte 1 is sandwiched between the anode 2 and the cathode 3. The anode 2 and the cathode 3 are electrically connected via a load. For example, if (HfMg) (WO₄)₃ is used as the solid electrolyte 1, a Au—Mg alloy having a high Mg content is used as the anode 2, and a Au—Mg alloy having a low Mg content is used as the cathode 3, a difference in Mg concentration can be created between the anode 2 and the cathode 3, and an electromotive force will be generated due to the difference in Mg concentration between the anode 2 and cathode 3, as described by the Nernst formula. The concentration cell of the present embodiment can be provided again with the Mg concentration difference in the form shown hereinabove (FIG. 1) by applying a reverse voltage and can be charged as a battery. Therefore, the solid electrolyte battery of the present embodiment can be employed as a secondary battery. Furthermore, if a metal material forming an alloy with Mg is used as the electrode material, then the difference in concentration can be easily provided between the anode 2 and cathode 3 and, therefore, can be used advantageously.

In accordance with the present invention, both a high ion conductivity and a high-density charge transfer of polyvalent ions can be realized. As a result, a solid electrolyte advantageously suitable for electrochemical devices such as batteries, gas sensors, and ion concentration sensors can be provided.

The present invention makes it possible to obtain a solid electrolyte having a high ion conductivity and a high-density charge transfer and can be widely applied to electrochemical devices such as batteries, gas sensors, and ion concentration sensors.

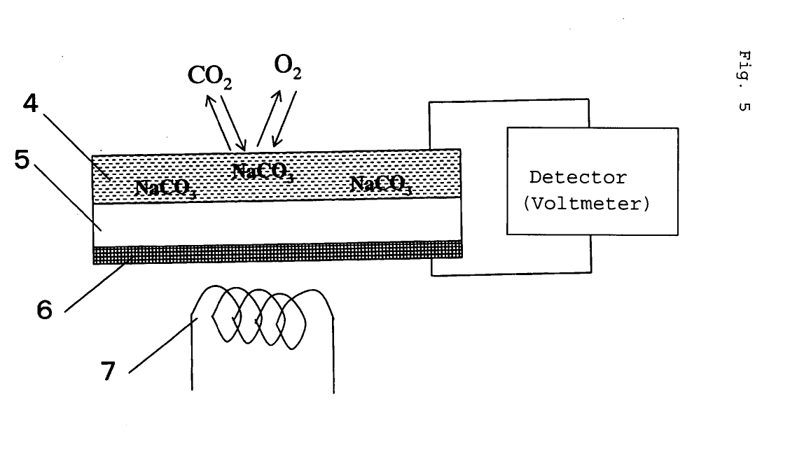

FIG. 5 shows schematically a solid electrolyte gas sensor. In an example where sodium carbonate (NaCO₃), which can react with CO₂ gas, is used as an auxiliary substance, the CO₂ gas reacts with the sodium carbonate and the concentration of sodium ions in the gas detection electrode changes according to the CO₂ concentration. As a result a concentration distribution of sodium ions is produced in the solid electrolyte disposed between the gas detection electrode and a reference electrode. Heating the sensor with a heater enables the transfer of ions present in the solid electrolyte. Therefore, a concentration cell is formed between the gas detection electrode and reference electrode and an electromotive force is generated. The concentration of CO₂ can be found by detecting the change of the electromotive force.

### EXAMPLES

The examples are described and the specific features of the present invention are explained below in greater detail. However, the present invention is not limited to the scope of the examples.

### Example 1

(HfMg) (WO₄)₃ was prepared and ion conductivity was measured up to a temperature of 700° C.

HfO₂ (manufactured by Kansai Chemical Co. Ltd., purity 99.5%), MgO (manufactured by Kishida Chemical Co., Ltd.), and WO₃ (manufactured by Kojundo-Kagaku Kenkyusho Co., purity 4N) were accurately weighed as starting materials at a molar ratio of 1:1:3, and mixing and grinding were carried out for 144 h with a wet ball mill using pure water as a solvent. The mixture was dried overnight to remove moisture and then the starting material powder thus obtained was calcined at 1050° C. and a calcined power was obtained. Coarse grinding was carried out with a grinding machine, followed by press molding and firing for 4 h at a temperature of 1100° C. A total of four samples were fabricated. One of them was ground to obtain the powder for powder X-ray diffraction, it was confirmed that the powder was (HfMg) (WO₄)₃.

A sample for ion conductivity measurements was molded and fired so as to obtain a square shape with a side of 5 mm and a height of 10 mm after firing. An electrode was formed by coating a gold paste (manufactured by Tanaka Precious Metals Co.), drying, and baking at 700° C.

Ion conductivity was measured by using an alternating current impedance method and electric conductivity for a range from 300° C. to 700° C. in the air was calculated.

As a comparative example, ion conductivity of Al₂(WO₄)₃ was measured as a comparative example. Al(OH)₃ (manufactured by Kansai Chemical Co., Ltd., purity 99.5%) and WO₃ (manufactured by Kojundo-Kagaku Kenkyusho Co., purity 4N) were accurately weighed as starting materials at a molar ratio of 2:3, and similarly to Example 1, processing in a wet ball mill and drying were conducted in the same manner as in Example 1, then calcining was carried out at 900° C., and coarse grinding was conducted with a grinding machine to fabricate a calcined powder. The calcined powder was press molded and firing was then carried out for 4 h at a temperature of 1100° C. Grinding was carried out in the same manner as in Example 1 and the crystal system was confirmed by powder X-ray diffraction.

The sample of Al₂(WO₄)₃ as a comparative example was also formed into a square shape with a side of 5 mm and a height of 10 mm after firing. An electrode was formed with a gold paste (manufactured by Tanaka Precious Metals Co.) by baking.

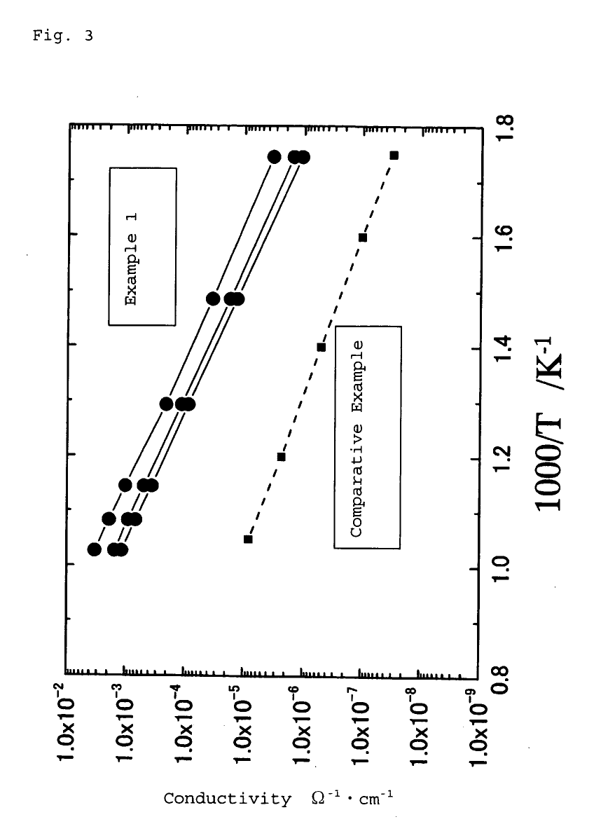

The results are shown in FIG. 3 and Table 1. The results of the below described Examples 2 to 4 are also shown in Table 1.

TABLE 1

| | | Electric |
|---|---|---|
| | | conductivity at |
| | Material | 600° C. (Ω⁻¹ · cm⁻¹) |
| Example 1 | (HfMg)(WO₄)₃ | 3.5 × 10⁻⁴ |
| | | 4.8 × 10⁻⁴ |
| | | 1.0 × 10⁻³ |
| Example 2 | (ZrMg)(WO₄)₃ | 3.0 × 10⁻³ |
| Example 3 | [(Hf_{0.5}Zr_{0.5})Mg](WO₄)₃ | 2.3 × 10⁻⁴ |
| Example 4 | [Zr(Mg_{0.5}Ca_{0.5})](WO₄)₃ | 1.4 × 10⁻⁴ |
| | [Hf(Mg_{0.7}Sr_{0.3})](WO₄)₃ | 1.1 × 10⁻⁴ |
| | [Zr(Mg_{0.7}Ba_{0.3})](WO₄)₃ | 1.8 × 10⁻⁴ |
| | [Hf(Mg_{0.5}Ca_{0.3}Sr_{0.2})](WO₄)₃ | 8.1 × 10⁻⁵ |
| | (ZrMg)(MoO₄)₃ | 3.5 × 10⁻⁴ |
| | [Hf(Mg_{0.8}Ca_{0.2})](MoO₄)₃ | 5.8 × 10⁻⁴ |
| | (HfMg)[(WO₄)_{0.5}(MoO₄)_{0.5}]₃ | 9.4 × 10⁻⁴ |
| Comparative | Al₂(WO₄)₃ | 4.0 × 10⁻⁶ |
| Example | | |

Electric conductivity at 600° C. was 3˜10×10⁻⁴ Ω⁻¹·cm⁻¹ with (HfMg) (WO₄)₃ and 4×10⁻⁶ Ω⁻¹·cm⁻¹ with Al₂(WO₄)₃, that is, an electric conductivity of the composition of the present invention was higher by two orders of magnitude. The ion radius of Al³⁺ is 0.5 Å and the ion radius of Mg²⁺ is 0.7 Å. Though the ion radius of Al³⁺ is less, (HfMg) (WO₄)₃ has a higher electric conductivity. This is because trivalent ions have higher bonding strength in a crystal lattice and it is more difficult for ion to move. This was found to be why the solid electrolyte in accordance with the present invention has good ion conductivity.

It is generally considered that in inorganic solid electrolytes, the presence of ions with a valence higher than movable ions in the lattice produces a profitable effect on conductivity of the movable ion. In the solid electrolyte in accordance with the present invention, tetravalent ions (Hf⁴⁺) are present in the crystal lattice and form strong ion bonds with WO₄²⁻ regular tetrahedrons. This is supposedly why a crystal state is formed which is favorable for conductivity of divalent ions.

Two samples fabricated in the same manner as in Example 1 were prepared to confirm the transfer of Mg²⁺ ions and one of them was directly used for the elemental analysis of the cross section. The elemental analysis of the cross section of the other sample was conducted after 10 h under a DC voltage of 10 V at a temperature of 600° C. The results are shown in Table 2. When the Mg/Hf ratio was compared for the vicinity of the electrode on the voltage application side and the electrode on the 0 V side, the concentration of Mg between the two electrodes in a sample after current conduction was found to be different from that in the sample before current conduction. In the vicinity of the electrode on the voltage application side, the Mg/Hf ratio clearly decreased and Mg present in the solid electrolyte was found to be transferred by the application of the DC voltage. As a result, Mg²⁺ were confirmed to be movable ions in the solid electrolyte in accordance with the present invention.

TABLE 2
Results of elemental analysis of cross section (Mg/Hf ratio)

| | In the vicinity of | In the vicinity |
|---|---|---|
| | electrode on the voltage | of electrode on |
| | application side | the 0 V side |
| Sample before current | 1.02 | 1.00 |
| conduction | | |
| Sample after current | 0.65 | 1.38 |
| conduction | | |

### Example 2

(ZrMg) (WO₄)₃ was fabricated and ion conductivity was measured up to a temperature of 700° C.

ZrO₂ (manufactured by Daiichi Kigenso Kagaku Kogyo Co., purity 99.5%), MgO (manufactured by Kishida Chemical Co., Ltd.), and WO₃ (manufactured by Kojundo-Kagaku Kenkyusho Co., purity 4N) were accurately weighed as starting materials at a molar ratio of 1:1:3, and mixing and grinding were carried out for 144 h with a wet ball mill using pure water as a solvent. The mixture was dried overnight to remove moisture and then the starting material powder thus obtained was calcined at 1000° C. and a calcined powder was prepared. Coarse grinding was carried out with a grinding machine, followed by press molding and main firing for 4 h at a temperature of 1050° C. A total of two samples were fabricated. One of them was ground to obtain the powder for powder X-ray diffraction. it was confirmed that the powder was (ZrMg) (WO₄)₃.

A sample for ion conductivity measurements was molded and fired so as to obtain square shape with a side of 5 mm and a height of 10 mm after firing. An electrode was formed by coating a gold paste (manufactured by Tanaka Precious Metals Co.) in the same manner as in Example 1.

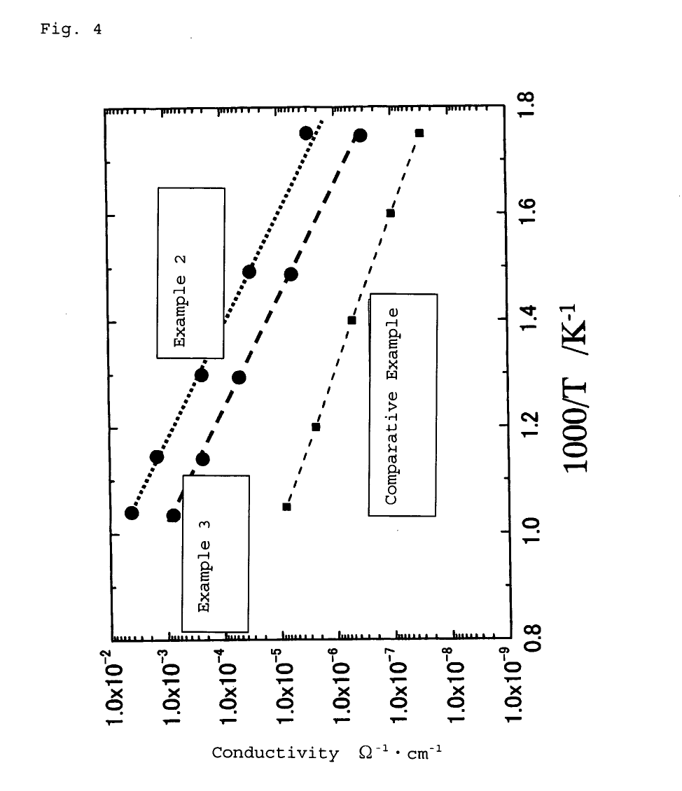

Ion conductivity was measured by using an alternating current impedance method and electric conductivity for a range from 300° C. to 700° C. in the air was calculated. The results obtained are shown together with those obtained in Example 3 in FIG. 4 and Table 1. Those results demonstrated that electric conductivity in Example 2 was also by two orders of magnitude or more higher than that in the comparative example.

### (Example 3)

[(Hf_{0.5}Zr_{0.5})Mg] (WO₄)₃ was fabricated and ion conductivity was measured up to a temperature of 700° C.

HfO₂ (manufactured by Kansai Chemical Co. Ltd., purity 99.5%), ZrO₂ (manufactured by Daiichi Kigenso Kagaku Kogyo Co., purity 99.5%), MgO (manufactured by Kishida Chemical Co., Ltd.), and WO₃ (manufactured by Kojundo-Kagaku Kenkyusho Co., purity 4N) were accurately weighed as starting materials at a molar ratio of 1:1:2:6. Processing in a wet ball and drying were conducted in the same manner as in Example 1, followed by calcining at 900° C. Coarse grinding was carried out with a grinding machine to obtain a calcined powder. The calcined powder was press molded and main firing was carried out for 4 h at a temperature of 1100° C. to obtain a sample. The sample was ground and crystal system thereof was confirmed by powder X-ray diffraction in the same manner as in Example 1.

A sample for ion conductivity measurements was molded and fired so as to obtain a square shape with a side of 5 mm and a height of 10 mm after firing. An electrode was formed by coating a gold paste (manufactured by Tanaka Precious Metals Co.) in the same manner as in Example 1.

Ion conductivity was measured by using an alternating current impedance method and electric conductivity for a range from 300° C. to 700° C. in the air was calculated. The results obtained are shown together with those obtained in Example 2 in FIG. 4 and Table 1. Those results demonstrated that electric conductivity obtained was by about two orders of magnitude higher than that in the comparative example.

### Example 4

In Example 4, the below-described materials in accordance with the present invention were prepared and electric conductivity thereof was measured at 600° C.

Tungsten oxides represented by formulas [Zr(Mg_{0.5}Ca_{0.5})](WO₄)₃, Hf(Mg_{0.7}Sr_{0.3})](WO₄)₃, [Zr(Mg_{0.7}Ba_{0.3})](WO₄)₃, and [Hf(Mg_{0.5}Ca_{0.3}Sr_{0.5})](WO₄)₃, molybdenum oxides represented by formulas (ZrMg) (MoO₄)₃ and [Hf(Mg_{0.8}Ca_{0.2})](MoO₄)₃ and molybdenum tungsten mixed oxide represented by formula (HfMg) [(WO₄)_{0.5} (MoO₄)_{0.5}]₃ were employed as samples for measurements.

HfO₂, ZrO₂, MgO, CaCO₃, SrCO₃, BaCO₃, WO₃, and MoO₃ were used as starting materials, those starting materials were accurately weighed to obtain the desired oxides, and ball mill processing, drying, calcining, and coarse grinding were carried out in the same manner as in Example 1 to fabricate calcined powders of seven types. The calcining of tungsten oxides was carried out at 900 to 1000° C., molybdenum oxides at 700 to 800° C., and molybdenum tungsten complex oxide at 850° C., and crystal systems thereof were confirmed by powder X-ray diffraction.

Press molding was carried out so as to obtain a square shape with a side of 5 mm and a height of 10 mm after firing, main firing was carried out and samples of seven types were obtained for measuring ion conductivity. The main firing of tungsten oxides was carried out at a temperature of 1050 to 1100° C., molybdenum oxides at 850 to 900° C., and molybdenum tungsten complex oxide at 900° C. After the firing, electrodes were formed by using and baking a gold paste in the same manner as in Example 1.

Ion conductivity was measured by using an alternating current impedance method and electric conductivity at 600° C. in the air was calculated. The results are shown in Table 1. Those results demonstrated that electric conductivity obtained was higher than that in the comparative example.

### Example 5

Measurement of Electromotive Force of Concentration Cell

A concentration cell was fabricated by using (ZrMg) (WO₄)₃ fabricated in Example 2 and electromotive force thereof was measured.

Au—Mg alloy electrodes were formed by simultaneous film deposition by using a two-element sputtering apparatus and Mg and Au targets. The content of elements in the Mg—Au alloy was controlled by changing respective deposition rates.

(ZrMg) (WO₄)₃ was press molded to obtain a diameter of 20 mm and a thickness of 2 mm after firing and then main firing was carried out. A sample was then fabricated by polishing both surfaces to obtain a thickness of 0.6 mm. Electrodes were formed on both surfaces of the sample by controlling the film deposition rate of the sputtering apparatus so as to obtain an anode from Au10-Mg90 (volume ratio) and cathode from Au90-Mg10 (volume ratio).

Platinum wires were joined with a gold paste to the anode and cathode of the fabricated solid electrolyte secondary battery and the sample was placed into an electric furnace. The electric furnace was then heated to 600° C. An electromotive force was then measured outside the electric furnace with the platinum wires by using a potentiostat/galvanostat.

After the initial value of the electromotive force of 0.7 V was obtained, it gradually decreased, assumed a value of about 0.1 V after several hours and was almost stabilized, showing little change.

After the concentration cell was discharged, it was charged by applying a reverse voltage of 5 V between the anode and cathode, while maintaining the temperature of 600° C., and allowing to stay in this state for 10 h. The electromotive force was measured again after the charging and an electromotive force of 0.75 V was obtained, thereby confirming that the solid electrolyte battery in accordance with the present invention is a rechargeable secondary battery.

What is claimed is:

1. A solid electrolyte substantially consisting of a crystal body represented by a chemical formula (RM) (QO₄)₃, wherein R is at least one selected from the group consisting of Zr and Hf, M is at least one species of Mg, Ca, Sr, Ba, and Ra, and Q is at least one selected from the group consisting of W and Mo.

2. The solid electrolyte according to claim 1, wherein M comprises at least Mg.

3. The solid electrolyte according to claim 1, wherein M is a mixed system of Mg and at least one selected from the group consisting of Ca, Sr, Ba, and Ra.

4. The solid electrolyte according to claim 1, wherein the crystal system of the crystal body is an orthorhombic system.

5. The solid electrolyte according to claim 1, wherein the electric conductivity at 600° C. of the solid electrolyte is 8×10⁻⁵ Ω⁻¹·cm⁻¹ or more.

6. A laminated body comprising (1) an anode, (2) a cathode, and (3) a solid electrolyte sandwiched between the anode and the cathode, wherein the solid electrolyte is the solid electrolyte according to claim 1.

7. The laminated body according to claim 6, wherein the anode is (a) a divalent metal of at least one selected from the group consisting of Mg, Ca, Sr, Ba, and Ra or (b) an alloy comprising at least one selected from the group consisting of such divalent metals.

8. The laminated body according to claim 6, wherein the cathode is an alloy comprising at least one selected from the group consisting of divalent metals of at least one selected from the group consisting of Mg, Ca, Sr, Ba, and Ra.

9. The laminated body according to claim 6, wherein M comprises at least Mg.

10. The laminated body according to claim 6, wherein M is a mixed system of Mg and at least one selected from the group consisting of Ca, Sr, Ba, and Ra.

11. The laminated body according to claim 6, wherein the crystal system of the crystal body is an orthorhombic system.

12. The laminated body according to claim 6, wherein the electric conductivity at 600° C. of the solid electrolyte is 8×10⁻⁵ Ω⁻¹·cm⁻¹ or more.

13. A secondary battery having a laminated body comprising (1) an anode, (2) a cathode, and (3) a solid electrolyte sandwiched between the anode and the cathode, wherein the solid electrolyte is the solid electrolyte according to claim 1.

14. The secondary battery according to claim 13, wherein the anode is (a) a divalent metal of at least one selected from the group consisting of Mg, Ca, Sr, Ba, and Ra or (b) an alloy comprising at least one selected from the group consisting of such divalent metals.

15. The secondary battery according to claim 13, wherein the cathode is an alloy comprising at least one selected from the group consisting of divalent metals of at least one selected from the group consisting of Mg, Ca, Sr, Ba, and Ra.

16. The secondary battery according to claim 13, wherein M comprises at least Mg.

17. The secondary battery according to claim 13, wherein M is a mixed system of Mg and at least one selected from the group consisting of Ca, Sr, Ba, and Ra.

18. The secondary battery according to claim 13, wherein the crystal system of the crystal body is an orthorhombic system.

19. The secondary battery according to claim 13, wherein the electric conductivity at 600° C. of the solid electrolyte is 8×10⁻⁵ Ω⁻¹·cm⁻¹ or more.

20. The secondary battery according to claim 13, wherein (A) the anode is (a) a divalent metal of at least one selected from the group consisting of Mg, Ca, Sr, Ba, and Ra or (b) an alloy comprising at least one selected from the group consisting of such divalent metals; (B) the cathode is an alloy comprising at least one selected from the group consisting of divalent metals of at least one selected from the group consisting of Mg, Ca, Sr, Ba, and Ra; and (C) the divalent metal content of the anode is different from that of the cathode.
